(19) United States
(12) Patent Application Publication
(10) Pub. No.: US 2026/0238146 A1
(43) Pub. Date: Aug. 13, 2026

(54) LABORATORY APPARATUS HAVING A MOVABLE ELEMENT AND A DRIVE DEVICE

(71) Applicant: HANS HEIDOLPH GMBH, Kelheim (DE)

(72) Inventors: Andrej JARRESCH, Schwabach (DE); Vlad VASILIU, Schwabach (DE)

(73) Assignee: HANS HEIDOLPH GMBH, Kelheim (DE)

(21) Appl. No.: 19/115,048

(22) PCT Filed: Sep. 25, 2023
(86) PCT No.: PCT/EP2023/076426

§ 371 Date: Apr. 6, 2026

(30) Foreign Application Priority Data
Sep. 26, 2022 (DE) 20 2022 105 402.9

(51) Int. Cl. H02P 8/16; H02P 21/22

(52) U.S. Cl. CPC H02P 8/16; H02P 21/22

(57) ABSTRACT

A laboratory apparatus (100) comprises a movable element (10) and a drive device (50) for moving the movable element (10). The drive device (50) includes a stepper motor (20) and a control unit (30) for controlling the stepper motor (20). The control unit (30) is designed to control the stepper motor (20) by way of field-oriented control.

The present invention relates to a laboratory apparatus with a movable element and a drive device for the same.

Laboratory apparatuses are used in laboratory operations, for example in the fields of physics, chemistry, biology and pharmacy. Some of these laboratory apparatuses have movable elements through which substances are conveyed or mixed, for example. These include peristaltic pumps, shaker-mixers, laboratory stirrers and rotary evaporators.

Such a movable element is usually driven by a DC motor or a shaded-pole motor. However, these types of motors only provide low torque at low speeds. In order to achieve the torque required for operation in a laboratory apparatus, such a motor is operated at a high speed, which is then reduced to the required speed via a gearbox (a reduction gear). Such a drive is complex and contains many parts. On the other hand, designing such a motor for high torques at low speeds would require large dimensions of the motor, making it unsuitable for use in many laboratory apparatuses.

The object of the present invention is to provide a drive device for a laboratory apparatus and a laboratory apparatus with this drive device, which are simplified compared to the conventional drive and contain fewer parts.

This object is achieved by a laboratory apparatus according to claim 1. Further developments of the invention are specified in the dependent claims.

The laboratory apparatus according to the invention contains a movable element and a drive device for moving the movable element. The drive device contains a stepper motor and a control unit for controlling the stepper motor. The control unit is designed to control the stepper motor by means of a field-oriented control.

Field-oriented control (FOC), also called vector control, is a control method that aims to set the excitation flux and the armature magnetomotive force of a motor as perpendicular to each other as possible. This makes it possible to achieve the maximum torque of the motor. For this purpose, a control loop with feedback is provided in which data recorded on the machine is processed via transformations.

The implementation of the drive device by a stepper motor and the control of the stepper motor by means of field-oriented control make it possible, for example, to simplify the structure of the laboratory apparatus and to reduce the number of parts it contains. This can, for example, lead to simplified production of the laboratory apparatus and lower manufacturing costs.

Preferably, the movable element is connected to the stepper motor without a gear. This can, for example, lead to a further reduction in the number of parts, further simplifying production and further reducing manufacturing costs.

Preferably, the movable element is connected to a rotor of the stepper motor via a shaft. The movable element may also be formed by a shaft or contain a shaft, drivingly connected to the output shaft of the stepper motor or formed integrally therewith. This makes it possible, for example, to create a particularly simple way of connecting the movable element to the stepper motor.

Preferably, the field-oriented control is designed so that the speeds and/or torques required to drive the movable element are generated directly by the stepper motor. “Control design” refers to the dimensioning of the individual function blocks contained in a control loop used to carry out the control. In other words, the design of the control system comprises an appropriate selection of the parameters of the transfer functions of these function blocks. Such a design of the control can, for example, be used to enable a gear-less connection of the movable element to the stepper motor.

Preferably, the drive device further includes a two-phase inverter for generating a two-phase alternating voltage from an input direct voltage, wherein the output of the two-phase inverter is connected to the stepper motor via two motor leads. By controlling the stepper motor using a sinusoidal alternating voltage, it is possible, for example, to avoid step losses of the stepper motor and reduce the running noise.

Preferably, the stepper motor includes an encoder for outputting an encoder signal containing information about a position of the rotor in the stepper motor. This makes it possible, for example, to carry out field-oriented control of the stepper motor depending on the current rotor position.

Preferably, the control unit includes a position and speed determination unit for determining a rotor angle, an actual position and an actual speed from the encoder signal output by the encoder and from current measurement signals that reflect the currents flowing in the two motor leads. This makes it possible, for example, to provide the actual variables of the stepper motor operation required for field-oriented control.

Preferably, the control unit further includes
a first controller, preferably a PI controller, for generating a target speed from a deviation between a predetermined target position and the actual position,
a second controller, preferably a PI controller, for generating a target control signal from a deviation between the target speed and the actual speed,
a first transformation unit for performing a Park transformation to generate a first control signal and a second control signal from the current measurement signals and the rotor angle,
a third controller, preferably a PI controller, for generating a third control signal from a deviation between the target control signal and the first control signal,
a fourth controller, preferably a PI controller, for generating a fourth control signal from the second control signal and
a second transformation unit for performing an inverse Park transformation to generate voltage control signals from the third control signal, the fourth control signal and the rotor angle,
wherein the voltage control signals are applied to the two-phase inverter for controlling the generation of the two-phase alternating voltage.

This selection of individual function blocks and their arrangement in a control loop makes it possible, for example, to provide a concrete structure for the field-oriented control of the stepper motor.

Preferably, the control unit further includes a maximum torque determination unit for calculating a maximum torque, wherein the second controller is configured to generate the target control signal taking into account the maximum torque calculated by the maximum torque determination unit. This makes it possible, for example, to prevent the control loop from becoming unstable at higher speeds.

Preferably, the control unit further includes a torque current determination unit for calculating a value of the first control signal required to achieve a predetermined torque, and a torque current limiting unit for limiting the value of the first control signal calculated by the torque current determination unit. This makes it possible, for example, to prevent an over-current and any resulting overheating or damage to the motor.

Preferably, the control unit further includes a decoupling network for decoupling the control for the first control signal and the second control signal. This makes it possible, for example, to control the magnetic flux and torque of the motor separately and thus achieve better motor dynamics.

Preferably, the laboratory apparatus is a laboratory stirrer, a peristaltic pump, a rotary evaporator or a shaker-mixer. This makes it possible, for example, to apply the effects of the invention to the respective types of laboratory apparatus.

A method according to the invention for controlling a movable element in a laboratory apparatus comprises connecting the movable element to a stepper motor and controlling the stepper motor by means of a field-oriented control. Preferably, the field-oriented control is designed so that the speeds and/or torques required to drive the movable element are generated directly by the stepper motor.

With such a method and its developments described below, for example, the same effects can be achieved as with the laboratory apparatus according to the invention.

Preferably, the method according to the invention further comprises
generating a two-phase alternating voltage using a two-phase inverter from an input direct voltage and applying the two-phase alternating voltage as operating voltage to the stepper motor,
outputting an encoder signal containing information about a position of the rotor in the stepper motor by means of a decoder contained in the stepper motor,
determining a rotor angle, an actual position and an actual speed from the encoder signal output by the encoder and from current measurement signals that reflect the currents flowing in the two motor leads, by means of a position and speed determination unit,
generating a target speed from a deviation between a predetermined target position and the actual position by means of a first controller,
generating a target control signal from a deviation between the target speed and the actual speed by means of a third controller,
performing a Park transformation to generate a first control signal and a second control signal from the current measurement signals and the rotor angle, by means of a first transformation unit,
generating a third control signal from a deviation between the target control signal and the first control signal by means of a third controller,
generating a fourth control signal from the second control signal by means of a fourth controller,
performing an inverse Park transformation to generate voltage control signals from the third control signal, the fourth control signal and the rotor angle, by means of a second transformation unit, and
applying the voltage control signals to the two-phase inverter for controlling the generation of the two-phase alternating voltage.

Further features and advantages of the invention will be apparent from the following description of exemplary embodiments based on the attached drawings.

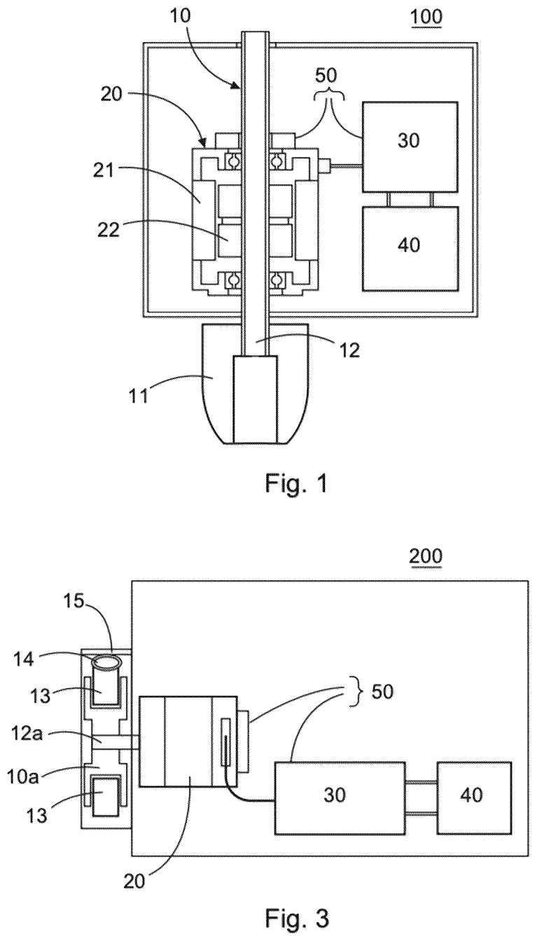

FIG. 1 is a schematic representation of a laboratory apparatus according to a first embodiment of the present invention.

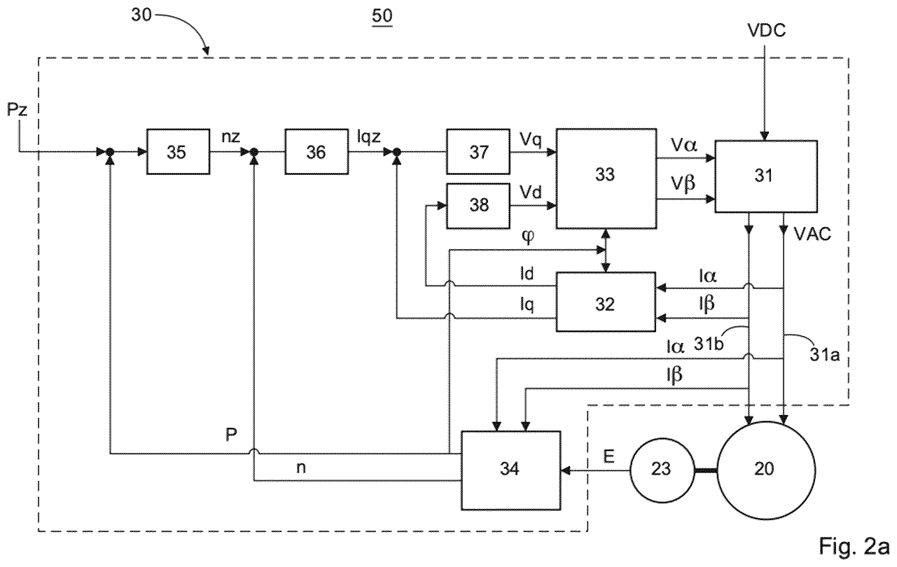

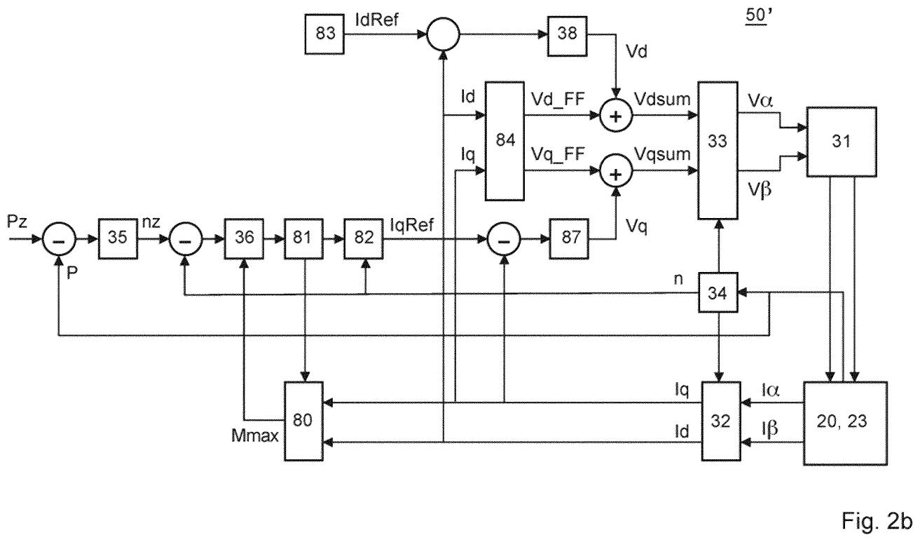

FIG. 2a is a schematic block diagram of a drive device included in the laboratory apparatus shown in FIG. 1.

FIG. 2b is a schematic block diagram of a modification of the drive device shown in FIG. 2a.

FIG. 3 is a schematic representation of a laboratory apparatus according to a second embodiment of the present invention.

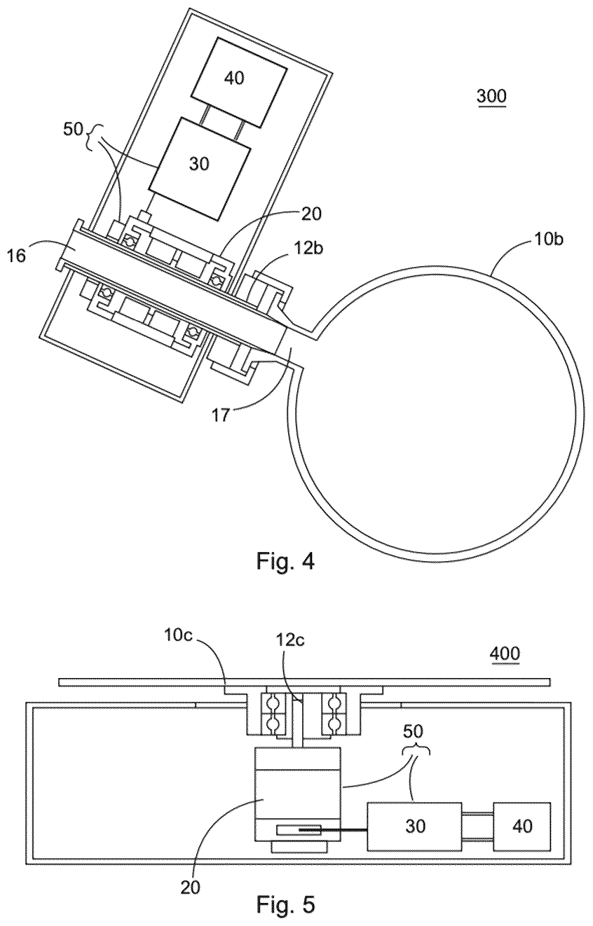

FIG. 4 is a schematic representation of a laboratory apparatus according to a third embodiment of the present invention.

FIG. 5 is a schematic representation of a laboratory apparatus according to a fourth embodiment of the present invention.

Embodiments of the present invention will now be described with reference to the accompanying drawings. FIG. 1 is a schematic representation of a laboratory apparatus 100 according to a first embodiment.

According to the present embodiment, the laboratory apparatus 100 is designed as a laboratory stirrer. The movable element is formed by a stirring rod 10. The stirring rod 10 comprises a stirring head 11 and a shaft 12 connected thereto. The stirring rod can be used to stir substances in a vessel (not shown) into which the stirring head is immersed.

A stepper motor 20 is provided to drive the stirring rod 10. During operation of the laboratory apparatus, the stepper motor 20 rotates the stirring head 11 via the shaft 12. The stepper motor 20 contains a stator 21 and a rotor 22. The stirring head 11 is connected to the rotor 22 of the stepper motor via the shaft 12.

Furthermore, a control unit 30 is provided which is designed to control the stepper motor 20. The stepper motor 20 and the control unit 30 together form a drive device 50 for the stirring rod 10. To supply the stepper motor 20 and the control unit 30, the laboratory apparatus 100 further contains a power supply 40, for example a wide-range power supply, for generating internal supply voltages from an externally supplied mains voltage.

The control unit 30 is designed to control the stepper motor 20 by way of field-oriented control. FIG. 2a is a schematic block diagram of the drive device 50, which serves to explain this field-oriented control.

The stepper motor 20 contains an encoder 23 which outputs an encoder signal E containing information about a position of the rotor 22 in the stepper motor 20.

The control unit 30 contains a two-phase inverter 31 which generates a two-phase alternating voltage VAC from a direct voltage VDC provided by the power supply 40. The output of the two-phase inverter is connected to the stepper motor 20 via two motor leads 31a, 31b. The alternating voltage VAC is applied as operating voltage to the stator 21 of the stepper motor 20 via the motor leads 31a, 31b.

The control unit 30 further includes a first transformation unit 32 and a position and speed determination unit 34. The currents flowing in the motor supply lines 31a, 31b are detected via current sensors (not shown) and fed to the first transformation unit 32 and the position and speed determination unit 34 as current measurement signals Iα and Iβ.

The position and speed determination unit 34 determines a rotor angle φ, an actual position P and an actual speed n from the encoder signal E output by the encoder 23 and the current measurement signals Iα and Iβ. The rotor angle o denotes an angular position of the rotor 22 within the stepper motor in a range from 0° to 360°. The actual position, on the other hand, continues to count the angle and thus reaches a multiple of 360° when the rotor rotates several times.

A first controller 35, which is preferably designed as a PI controller, generates a target speed nz from a deviation between a predetermined target position Pz and the actual position P. A second controller 36, which is preferably designed as a PI controller, generates a target control signal Iqz from a deviation between the target speed nz and the actual speed n.

The first transformation unit 32 performs a Park transformation and generates from the current measurement signals Iα and Iβ and the rotor angle φ a first control signal Iq and a second control signal Id in a two-axis coordinate system with the axes d and q, which rotates with the rotor, so that Iq and Id represent temporally constant quantities in the stationary case. Id represents the magnetic flux density of the magnetic excitation in the rotor, and Iq is an expression for the torque generated by the rotor. Temporal changes in speed or torque result in temporal changes in Id or Iq.

A third controller 37, which is preferably designed as a PI controller, generates a third control signal Vq from a deviation between the target control signal Iqz and the first control signal Iq. A fourth controller 38, which is preferably designed as a PI controller, generates a fourth control signal Vd from the second control signal Id.

A second transformation unit 33 performs an inverse Park transformation and generates the voltage control signals Vα and Vβ from the third control signal Vq, the fourth control signal Vd and the rotor angle φ. The voltage control signals Vα and Vβ are applied to the two-phase inverter 31 and control the generation of the two-phase alternating voltage VAC.

The individual function blocks of this control loop are dimensioned in such a way, namely the parameters of the transfer functions of these function blocks are selected in such a way, that the stepper motor 20 directly generates the speed and torque required to drive the movable element 10.

This allows the movable element to be firmly connected to the stepper motor without any kind of gearing in between. Compared to conventional drive devices, the structure is simplified and the number of parts is reduced. This can also reduce production costs, for example.

Even if a gearbox is provided between the motor and the movable element, it can be dimensioned for a much lower reduction ratio and thus still achieve a simplification of the structure and a reduction in manufacturing costs. For example, a 1:1 gearbox can also be used.

Since the field-oriented control works with a sinusoidal alternating voltage and not with steps like in the conventional stepper motor control, a step loss cannot occur. Furthermore, the running noise that occurs with conventional stepper motor controls, which is very disturbing in many laboratory environments, is eliminated.

This control system allows full torque to be accessed even at the lowest motor speeds. By dimensioning the successive function blocks of the control loop, the positions of the movable element in the laboratory apparatus can be precisely approached and maintained.

These properties make the field-oriented controlled stepper motor a suitable drive for all types of laboratory apparatus that has a movable element.

FIG. 2b is a schematic block diagram of a drive device 50′, which is a modification of the drive device 50 shown in FIG. 2a. Identical elements are provided with the same reference numerals and will not be explained again in the following description.

In addition to the elements of the drive device 50, the drive device 50′ includes a maximum torque determination unit 80, a torque current determination unit 81, a torque current limiting unit 82, a reference signal generation unit 83 and a decoupling network 84.

The maximum torque determination unit 80 receives the first control signal Iq and the second control signal Id and calculates therefrom the maximum torque Mmax that can be applied at a specific operating point. The second controller 36 takes into account the maximum torque Mmax calculated by the maximum torque determination unit 80.

The torque current determination unit 81 receives the output signal of the second controller 36 and calculates a corresponding value of Iq required for a specific motor torque. The torque current limiting unit 82 receives the output signal of the torque current determination unit 81 and limits the value of Iq so that the condition Iq²+Id²≤Imax² is satisfied, where Imax is a maximum current.

The output signal of the torque current limiting unit 82 is a first reference signal Iqref (a reference signal for the first control signal Iq). The third controller 37 is supplied with a difference signal from the first reference signal Iqref and the first control signal Iq.

The reference signal generating unit 83 generates a second reference signal Idref (a reference signal for the second control signal Id). The fourth controller 38 is supplied with a difference signal from the second reference signal Idref and the second control signal Id.

The decoupling network 84 receives the first control signal Iq and the second control signal Id and is designed to decouple the control of the two components Iq and Id and thus the magnetic flux and the torque of the motor 20 from each other. The decoupling network 84 outputs a fifth control signal Vq_FF and a sixth control signal Vd_FF. The suffixes FF denote the fact that the fifth and sixth control signals are output from the decoupling network 84 in a feed-forward manner.

A first sum signal Vqsum from the third control signal Vq and the fifth control signal Vq_FF and a second sum signal Vdsum from the fourth control signal Vd and the sixth control signal Vd_FF are supplied to the second transformation unit 33.

Otherwise, the operation of all components is the same as described above for the drive device 50 and will not be described again here.

Using the drive device 50′, the same effects can be achieved as with the drive device 50. In addition, by calculating the maximum torque Mmax and taking it into account in the control, the control loop can be prevented from becoming unstable at higher speeds.

Furthermore, the current limitation by means of the torque current determination unit 81 and the torque current limiting unit 82 can prevent an over-current and any resulting overheating or damage to the motor.

Furthermore, better motor dynamics can be achieved by decoupling the two components Iq and Id using the decoupling network 84. In addition, this block can predict an expected open circuit voltage to compensate for it.

FIG. 3 is a schematic representation of a laboratory apparatus 200 according to a second embodiment. The laboratory apparatus 200 according to this embodiment is designed as a peristaltic pump (hose pump). The movable element is formed by a wheel 10a to which rollers 13 are attached on both sides. The wheel 10a is connected to the rotor of the stepper motor 20 via a shaft 12a.

During operation of the peristaltic pump, a hose 14 is pressed by the rollers 13 against a housing wall 15 and is thus clamped at these points. A medium contained in the hose between the clamped points is conveyed further within the hose 14 by the rotation of the wheel 10a.

To drive the wheel 10a, the laboratory apparatus 200 includes the drive device 50 containing the stepper motor 20 and the control unit 30 and the power supply 40 as described in the first embodiment. Thus, the advantageous effects of the first embodiment can also be achieved with a peristaltic pump.

FIG. 4 is a schematic representation of a laboratory apparatus 300 according to a third embodiment. The laboratory apparatus 300 according to this embodiment is designed as a rotary evaporator. The movable element is formed by an evaporator piston 10b.

The evaporator piston 10b is connected to the rotor of the stepper motor 20 via a shaft 12b. The shaft 12b can be designed as a hollow shaft through which a vapor passage 16 is inserted into an opening 17 of the evaporator piston 10b and seals it.

During operation of the rotary evaporator, the evaporator piston 10b is partially immersed in a heating bath (not shown) and set in rotation. Due to the heat supplied by the heating bath, a part of a substance contained in the evaporator piston 10b evaporates and is passed on through the vapor passage 16, for example into a condenser (not shown).

To drive the evaporator piston 10b, the laboratory apparatus includes the drive device 50 containing the stepper motor 20 and the control unit 30 and the power supply 40 as described in the first embodiment. Thus, the advantageous effects of the first embodiment can also be achieved in a rotary evaporator.

FIG. 5 is a schematic representation of a laboratory apparatus 400 according to a fourth embodiment. The laboratory apparatus 400 according to this embodiment is designed as a shaker-mixer. The movable element is formed by a shaking platform 10c. The shaking platform 10c is connected to the rotor of the stepper motor 20 via a shaft 12c.

During operation of the shaking-mixing apparatus, the shaking platform 10c is set into an oscillating movement, for example, by a rotation of the shaft 12c, depending on its bearing and the type of its connection to the shaft 12c. This causes substances in vessels (not shown) placed on the shaking platform 10c to be shaken and mixed.

To drive the shaking platform 10c, the laboratory apparatus 400 includes the drive device 50 containing the stepper motor 20 and the control unit 30 and the power supply 40 as described in the first embodiment. Thus, the advantageous effects of the first embodiment can also be achieved in a shaking-mixing device.

The embodiments described above are to be understood as non-limiting examples. The drive device according to the invention can also be used in other types of laboratory apparatus that have a movable element.

1. A laboratory apparatus, having
a movable element (10, 10a, 10b, 10c) and
a drive device (50) for moving the movable element (10, 10a, 10b, 10c),
wherein the drive device (50) includes
a stepper motor (20) and
a control unit (30) for controlling the stepper motor (20),
wherein the control unit (30) is designed to control the stepper motor (20) by way of field-oriented control.

2. The laboratory apparatus according to claim 1, wherein the movable element (10, 10a, 10b, 10c) is connected to the stepper motor (20) without a gear.

3. The laboratory apparatus according to claim 1, wherein the movable element (10, 10a, 10b, 10c) is connected to a rotor (22) of the stepping motor (20) via a shaft (12, 12a, 12b, 12c).

4. The laboratory apparatus according to claim 1, wherein the field-oriented control is designed such that the speeds and/or torques required for driving the movable element (10, 10a, 10b, 10c) are generated directly by the stepper motor (20).

5. The laboratory apparatus according to claim 1, wherein the drive device (50) further includes a two-phase inverter (31) for generating a two-phase alternating voltage (VAC) from an input direct voltage (VDC),
wherein the output of the two-phase inverter (31) is connected to the stepper motor (20) by means of two motor leads (31a, 31b).

6. The laboratory apparatus according to claim 1, wherein the stepper motor (20) includes an encoder (23) for outputting an encoder signal (E) containing information about a position of the rotor (22) in the stepper motor (20).

7. The laboratory apparatus according to claim 6, wherein the control unit (30) contains a position and speed determination unit (34) for determining a rotor angle (φ), an actual position (P) and an actual speed (n) from the encoder signal (E) output by the encoder (23) and from current measurement signals (Iα, Iβ) which reflect the currents flowing in the two motor leads (31a, 31b).

8. The laboratory apparatus according to claim 7, wherein the control unit (30) further includes a first controller (35), preferably a PI controller, for generating a target speed (nz) from a deviation between a predetermined target position (Pz) and the actual position (P).

9. The laboratory apparatus according to claim 8, wherein the control unit (30) further includes a second controller (36), preferably a PI controller, for generating a target control signal (Iqz) from a deviation between the target speed (nz) and the actual speed (n).

10. The laboratory apparatus according to claim 9, wherein the control unit (30) further includes:
a first transformation unit (32) for performing a Park transformation to generate a first control signal (Iq) and a second control signal (Id) from the current measurement signals (Iα, Iβ) and the rotor angle (φ),
a third controller (37), preferably a PI controller, for generating a third control signal (Vq) from a deviation between the target control signal (Iqz) and the first control signal (Iq),
a fourth controller (38), preferably a PI controller, for generating a fourth control signal (Vd) from the second control signal (Id), and
a second transformation unit (33) for performing an inverse Park transformation to generate voltage control signals (Vα, Vβ) from the third control signal (Vq), the fourth control signal (Vd) and the rotor angle (φ),
wherein the voltage control signals (Va, VB) are applied to the two-phase inverter (31) for controlling the generation of the two-phase alternating voltage (VAC).

11. The laboratory apparatus according to claim 10, wherein
the control unit (30) further includes a maximum torque determination unit (80) for calculating a maximum torque (Mmax) and
the second controller (36) is designed to generate the target control signal (Iqz) taking into account the maximum torque (Mmax) calculated by the maximum torque determination unit (80).

12. The laboratory apparatus according to claim 10, wherein the control unit (30) further includes:
a torque current determination unit (81) for calculating a value of the first control signal (Iq) required to achieve a predetermined torque, and
a torque current limiting unit (82) for limiting the value of the first control signal (Iq) calculated by the torque current determination unit (81).

13. The laboratory apparatus according to claim 10, wherein the control unit (30) further includes a decoupling network (84) for decoupling the control for the first control signal (Iq) and the second control signal (Id).

14. The laboratory apparatus according to claim 1, wherein the laboratory apparatus is a laboratory stirrer (100), a peristaltic pump (200), a rotary evaporator (300) or a shaker-mixer (400).
